(19) United States
(12) Patent Application Publication
(10) Pub. No.: US 2018/0045873 A1
(43) Pub. Date: Feb. 15, 2018

(54) Illumination Device

(71) Applicant: Bayerische Motoren Werke Aktiengesellschaft, Muenchen (DE)

(72) Inventors: Tobias MUELLER, Landshut (DE); Johannes RIEDEL, Muenchen (DE)

(21) Appl. No.: 15/716,585

(22) Filed: Sep. 27, 2017

Related U.S. Application Data
(63) Continuation of application No. PCT/EP2016/060366, filed on May 10, 2016.

(30) Foreign Application Priority Data
Jun. 3, 2015 (DE) 10 2015 210 299.8

(51) Int. Cl. F21V 8/00

(52) U.S. Cl. CPC G02B 6/001; G02B 1/04

(57) ABSTRACT

An illumination device includes a fiber composite material component, at least one light source, and at least one light-guiding body. The fiber composite material component is composed of a plastic matrix and a plurality of reinforcing fibers that are embedded in the plastic matrix. The light-guiding body has at least one light-inlet surface for coupling in light that is emitted from the light source, and at least one light-outlet surface for coupling light out. The light-guiding body is embedded in the plastic matrix of the fiber composite material component. The fiber composite material component is at least partially translucent to light coupled out of the light-outlet surface.

### CROSS REFERENCE TO RELATED APPLICATIONS

This application is a continuation of PCT International Application No. PCT/EP2016/060366, filed May 10, 2016, which claims priority under 35 U.S.C. §119 from German Patent Application No. 10 2015 210 299.8, filed Jun. 3, 2015, the entire disclosures of which are herein expressly incorporated by reference.

### BACKGROUND AND SUMMARY OF THE INVENTION

An illumination device is disclosed. The illumination device can in particular be a vehicle component, for example part of a vehicle body or part of the interior equipment of a vehicle

In the prior art it is known for vehicle components to be made from a fiber-composite material which can comprise carbon fibers, for example, which are embedded in a plastics matrix. The carbon fibers act as reinforcement fibers of the component, and the reinforcements can be laid out along the lines of flow of forces. Components from carbon-fiber reinforced plastics are distinguished by a low mass and, at the same time, by high rigidity and strength.

Apart from these properties, vehicle components made from fiber-composite material usually do not have any further functions. Furthermore, the carbon fibers that are embedded in the plastics matrix are most often not visible on the exterior such that, for example, the investment underlying the development and production of such vehicle components can be communicated to the customers only with difficulty.

It is an object of at least some embodiments to provide an illumination device which, apart from an illumination function, also has the advantages of components made from a fiber-composite material. It is a further object to improve the customer experience with fiber-reinforced components.

These and other objects are achieved by an illumination device according to embodiments of the invention.

The illumination device described herein has a fiber-composite material component, at least one light source, and at least one light-conducting body. The light source can be configured as a light-emitting diode, for example. The fiber-composite material component comprises a plastics matrix and a multiplicity of reinforcement fibers which are embedded in the plastics matrix. The reinforcement fibers are preferably so-called endless fibers which are embedded in the plastics matrix. The reinforcement fibers can be carbon fibers, glass fibers, and/or aramid fibers, for example. The plastics matrix can have a thermoplastic plastics material, for example, or be composed of a thermoplastic plastics material. The plastics matrix can, furthermore, have a thermosetting plastic, for example a resin or an artificial resin, respectively, or be composed of a thermosetting plastic.

The light-conducting body has at least one light-introduction face for coupling in light that is emitted from the light source, and at least one light-exit face for de-coupling light. The light-conducting body is embedded in the plastics matrix of the fiber-composite material component. The light-exit face can be at least partially covered by a material of the plastics matrix, for example, or be in direct physical contact with the plastics matrix, respectively. Furthermore, the light-exit face can be completely covered by a material of the plastics matrix. The light-conducting body in the lateral direction is preferably completely surrounded by the plastics matrix. For example, the plastics matrix can completely enclose the light-conducting body along a main direction of propagation of the light-conducting body. The material of the plastics matrix can be configured so as to be highly transparent, transparent, or opaque. The light-exit face of the light-conducting body preferably extends predominantly along a main direction of extent of the light-conducting body.

The fiber-composite material component is preferably at least partially translucent to light which is de-coupled from the light-exit face of the light-conducting body. In other words, the plastics matrix that surrounds the light-conducting body is at least partially transparent to light that is de-coupled from the light-exit face. For example, the illumination device can have a visual surface which is formed by the plastics matrix and through which light that is de-coupled from the light-exit face of the light-conducting body can exit such that said light can be experienced from outside the illumination device. The light-exit face can extend along a main direction of extent of the light-conducting body, for example.

According to one further embodiment, at least 3% of the radiation energy of the light that is coupled into the light-conducting body exits from the illumination device. This light, upon exiting from the light-exit face of the light-conducting body, preferably passes through a material of the plastics matrix before leaving the illumination device. According to one particularly preferred embodiment, at least 5% of the radiation energy of the light that is coupled into the light-conducting body exits from the illumination device via the plastics matrix, and according to one further preferred embodiment this is at least 10%.

According to one further embodiment, the light-conducting body has de-coupling elements for de-coupling light in a targeted manner. The de-coupling elements can be configured as diffusion particles within the light-conducting body, for example. Additionally or alternatively, the light-conducting body can have de-coupling elements which are configured as structured surface features, as roughened regions, and/or as microprisms. The de-coupling elements are preferably configured in such a manner that light that is coupled into the light-conducting body can be de-coupled along the main direction of extent of the light-conducting body.

According to one further embodiment, the light-exit face to light-introduction face ratio is at least 10 to 1. The light-exit face to light-introduction face ratio is particularly preferably at least 25 to 1.

According to one further embodiment, the light-conducting body is configured as an optical fiber. The light-conducting body can be configured as a glass fiber or as an optical polymer fiber or plastics fiber, for example. Preferably, light that is coupled into the optical fiber is de-coupled from the fiber at least in part radially with respect to a longitudinal axis of the optical fiber. The light-conducting body can also comprise a plurality of optical fibers, or be composed of a plurality of optical fibers. It is furthermore possible for the light-conducting body to be configured as a fiber optic bundle. The fiber optic bundle herein can include a multiplicity of optical fibers. The optical fibers are preferably configured as endless fibers.

According to one further embodiment, the light-conducting body comprises a plastics or is composed of a plastics. For example, the light-conducting body can be polycarbonate and/or polymethyl acrylate, or be composed of polycarbonate or polymethyl acrylate, respectively. The light-conducting body can furthermore comprise glass or be composed of glass. However, in principle the light-conducting body can also include other materials, in particular transparent materials, that are suitable for optical applications.

According to one further embodiment, the light-conducting body is configured in such a manner that light that is coupled into the light-conducting body at least in part is emitted laterally. For example, at least one light-exit face of the light-conducting body is perpendicular to the light-introduction face of the light-conducting body. For example, the light-conducting body can be configured as a so-called side light fiber, such as, for example, a polymer side light fiber or a side light glass fiber.

According to one further embodiment, the light-conducting body is embedded in the fiber-composite material component in such a manner that the surface of the light-conducting body at least in portions is spaced apart from a visual surface of the illumination device by at maximum 0.5 mm, preferably at maximum 0.1 mm. In the case of such an arrangement, a material which is slightly transparent or is opaque, respectively, can be used as the plastics matrix. It is furthermore possible for the light-conducting body to be embedded in the fiber-composite material component in such a manner that the surface of the light-conducting body is continuously spaced apart from the visual surface by at maximum 0.5 mm, or at maximum 0.1 mm, respectively.

According to one further embodiment, the light-conducting body is embedded in the fiber-composite material component in such a manner that the surface of the light-conducting body at least in portions is spaced apart from a visual surface of the illumination device by at least 0.1 mm, preferably by at least 0.5 mm. In the case of such an arrangement, a transparent to very transparent material should be employed as the plastics matrix. Furthermore, the light-conducting body can be embedded in the fiber-composite material component in such a manner that the surface of the light-conducting body is continuously spaced apart from the visual surface by at least 0.1 mm or at least 0.5 mm, respectively.

According to one further embodiment, the light source is embedded in the fiber-composite material component. For example, the light source can be embedded in the fiber-composite material component in such a manner that said light source is completely surrounded by a material of the plastics matrix. The light source is preferably disposed close to the light-introduction face of the light-conducting body such that as much light that is emitted from the light source as possible can be coupled into the light-conducting body. For example, the light source can physically contact the light-conducting body.

According to one further embodiment, the light source is disposed outside the fiber-composite material component. For example, the light-introduction face can be disposed on a surface of the fiber-composite material component, or be disposed so as to be at least close to the surface on a surface of the fiber-composite material component, such that light which is emitted from the light source that is disposed outside the fiber-composite material component can be coupled into the light-conducting body.

According to one further embodiment, the light-conducting body at least in regions is in physical contact with at least one reinforcement fiber of the fiber-composite material component. For example, the light-conducting body can be embedded in the fiber-composite material component in such a manner that the former is in physical contact with at least one reinforcement fiber along at least half the length of the latter. It is furthermore possible that one of the reinforcement fibers is embedded in the fiber-composite material component in such a manner that the light-conducting body, when viewed from a visual surface of the illumination device, is at least partially covered by the reinforcement fiber. For example, when viewed from the visual surface, at least half of the light-conducting body can be covered by the reinforcement fiber. Reinforcement fibers can be made visible on the exterior in a particularly impressive manner by means of the arrangements described.

According to one further embodiment, the illumination device has a multiplicity of light-conducting bodies which are embedded in the plastics matrix of the fiber-composite material component. For example, the various light-conducting bodies can all be configured as optical fibers such as, for example, glass fibers or polymer fibers, or as a fiber bundle. Furthermore, the light-conducting bodies can all be embodied as bodies that are configured so as to be planar, laminar, and/or tile-shaped and are composed of polycarbonate or of polymethyl acrylate, for example. It is furthermore also possible for some of the light-conducting bodies to be present as optical fibers or fiber bundles, respectively, and for some of the light-conducting bodies to be present as bodies configured so as to be laminar. For example, each of the light-conducting bodies can be assigned one light source. Alternatively, it is also possible for light that is emitted from one light source to be coupled into a plurality of light-conducting bodies.

According to one further embodiment, the reinforcement fibers of the fiber-composite material component are present in the form of a fiber bundle or of a plurality of fiber bundles. Furthermore, the reinforcement fibers can be embodied as a fibrous scrim, a fibrous woven fabric, a fibrous braiding and/or a fibrous embroidery.

According to one further embodiment, the illumination device has at least one sensor element for switching the light source and/or the light-conducting body or bodies, respectively. The sensor element is preferably embedded in the fiber-composite material component. For example, the sensor element can be connected to the light source or sources, respectively, of the illumination device, and or to the light-conducting body or bodies, respectively. Switching by use of the sensor element can be performed in a capacitive or thermal manner, for example. On account thereof, it is possible for the light source or the light-conducting body to be switched either by way of touching the illumination device, or alternatively in a non-contacting manner. The emission of light can be activated or deactivated, respectively, and/or the light output of the light source or sources, respectively, can be modified by switching the light source or sources, respectively. The transparency of the light-conducting body or bodies, respectively, can be varied by switching the light-conducting body or bodies, respectively, such that the quantity of light that exits the illumination device can be modified. For example, the sensor element can be connected to the light source or sources, respectively, or to the light-conducting body or bodies, respectively, by means of one or a plurality of the reinforcement fibers, or by means of one or a plurality of further electrically conductive fibers.

According to one further embodiment, the light-conducting body bundles a plurality of reinforcement fibers. For example, the reinforcement fibers can be guided or aligned by the light-conducting body. The light-conducting body can wrap a plurality of reinforcement fibers, for example, preferably by means of a multiplicity of wrappings. The reinforcement fibers that are bundled or wrapped, respectively, by the light-conducting body can be present in the form of a fiber bundle, for example.

According to one further embodiment, the light-conducting body is configured as a textile thread. The textile thread can fix and/or wrap a plurality of bundles of reinforcement fibers, for example. The textile thread can further interconnect, such as by sewing or tufting, for example, a plurality of scrims which each can comprise a multiplicity of bundles of reinforcement fibers.

According to one further embodiment, the reinforcement fibers are configured as fibers in the form of prepregs (pre-impregnated fibers), that is to say that the reinforcement fibers are pre-impregnated fibers, in particular fibers that are pre-impregnated with a plastics matrix.

According to one further embodiment, the illumination device has a plurality of light-conducting bodies wherein the distribution of the light-conducting bodies within the fiber-composite material component is dependent on the distribution of the reinforcement fibers. More light-conducting bodies are preferably provided in those regions having many reinforcement fibers than in those regions having few reinforcement fibers. For example, one light-conducting body can be provided for each reinforcement fiber. The respective light-conducting bodies herein in terms of the length thereof can be adapted to the length of the reinforcement fibers.

According to one further embodiment, at least some of the reinforcement fibers and/or the light-conducting body or bodies, respectively, by way of the arrangement of the former form a specific pattern, a symbol such as a trademark, for example, a figure, an emblem, one or a plurality of letters, or one or a plurality of numerals, respectively, or one or a plurality of letterings.

The features that have been described in the context of the light-conducting body can apply in an analogous manner to a multiplicity of light-conducting bodies which can be disposed in the illumination device. Further, the illumination device can have a multiplicity of light sources which can have the features that have been mentioned in the context of the light source described.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1A is a schematic illustration of an illumination device according to a first exemplary embodiment.

FIG. 1B is a schematic illustration of a light-conducting body of the illumination device from FIG. 1A, in a further view.

FIGS. 2 to 4A are schematic illustrations of illumination devices described herein, according to further exemplary embodiments.

FIG. 4B is a schematic illustration of the illumination device from FIG. 4A, in a further view.

FIG. 5 is a schematic illustration of an illumination device having a light-conducting body that bundles a plurality of reinforcement fibers, according to a further exemplary embodiment.

### DETAILED DESCRIPTION OF THE DRAWINGS

Same or functionally equivalent component parts in the exemplary embodiments and figures can in each case be provided with the same reference signs. In principle, the elements illustrated and the mutual size ratios thereof are not to be considered to scale. Rather, for the purpose of improved illustration and/or improved clarity, individual elements can be illustrated so as to be exaggerated in terms of the dimensions pertaining to thickness or size.

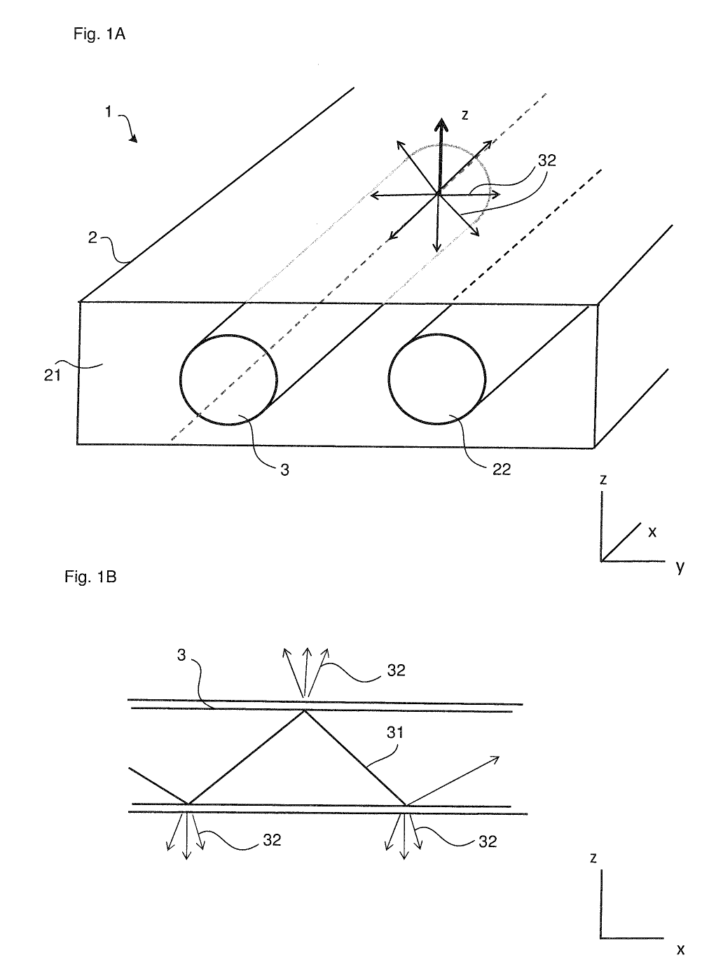

Various exemplary embodiments of illumination devices are illustrated in FIGS. 1A to 5. For improved clarity, a coordinate system having the spatial axes x, y, z, is plotted in each of the figures.

FIG. 1 shows a schematic illustration of an illumination device 1 according to a first exemplary embodiment. The illumination device 1 has a fiber-composite material component 2, a light source (not shown), and a light-conducting body 3. The fiber-composite material component 2 comprises a plastics matrix 21 and a multiplicity of reinforcement fibers 22 of which only one reinforcement fiber 22 is shown in an exemplary manner. The reinforcement fibers 22 are completely embedded in the plastics matrix 21, that is to say that the plastics matrix 21 completely encloses the reinforcement fibers 22. The reinforcement fibers 22 in the exemplary embodiment shown are embodied as carbon fibers. Alternatively, the reinforcement fibers can also be configured as aramid fibers or glass fibers, for example. The plastics matrix 21 in the exemplary embodiment shown is a thermoplastic plastics material. Alternatively, the plastics matrix 21 can also be composed of a thermosetting plastic, for example.

The light-conducting body 3 has at least one light-introduction face by way of which light, which is emitted from the light source, can be coupled into the light-conducting body. The light-conducting body 3 furthermore has a light-exit face by way of which the light that is coupled into the light-conducting body can be de-coupled again. The light-conducting body 3 is embedded in the plastics matrix 21 of the fiber-composite material component 2. Preferably, the plastics matrix 21 at least in the lateral direction completely encloses the light-conducting body 3. The light-conducting body 3 in the exemplary embodiment shown is embodied as a glass fiber, in particular as a side light fiber. Alternatively, the light-conducting body 3 can also be configured as a glass-fiber bundle, for example. Furthermore, the light-conducting body 3 can include one or a plurality of polymer fibers, or be composed of a plastics material such as, for example, of polycarbonate or polymethyl acrylate. It is furthermore possible for the illumination device 1 to have a multiplicity of light-conducting bodies 3 which are embedded in the plastics matrix 21 of the fiber-composite material component 2. The fiber-composite material component 2 is at least partially transparent to light which is de-coupled from the light-exit face of the light-conducting body 3. In the exemplary embodiment shown, light 32 that exits from the light-conducting body 3 is de-coupled radially with respect to a longitudinal axis of the light-conducting body 3.

The light-conducting body 3 from FIG. 1A is shown in a further schematic illustration in FIG. 1B, wherein a plan view of the x-z plane is illustrated. Light 31 that is emitted from the light source (not shown) and coupled into the light-conducting body 3 is de-coupled along the light-conducting body 3, for example along the main direction of extent of the light-conducting body 3. In other words: the light-exit face extends in the axial direction along the main direction of extent of the light-conducting body 3. The light-conducting body 3 can have means for de-coupling light along the main direction of extent, for example. The means for de-coupling light can be configured as, for example, a defined structured surface feature such as, for example, roughened regions or microprisms, or as diffusor particles that are embedded in the light-conducting body 3. The de-coupled light in FIG. 1B is provided with the reference sign 32. The fiber-composite material component 2 is at least partially translucent to the de-coupled light 32.

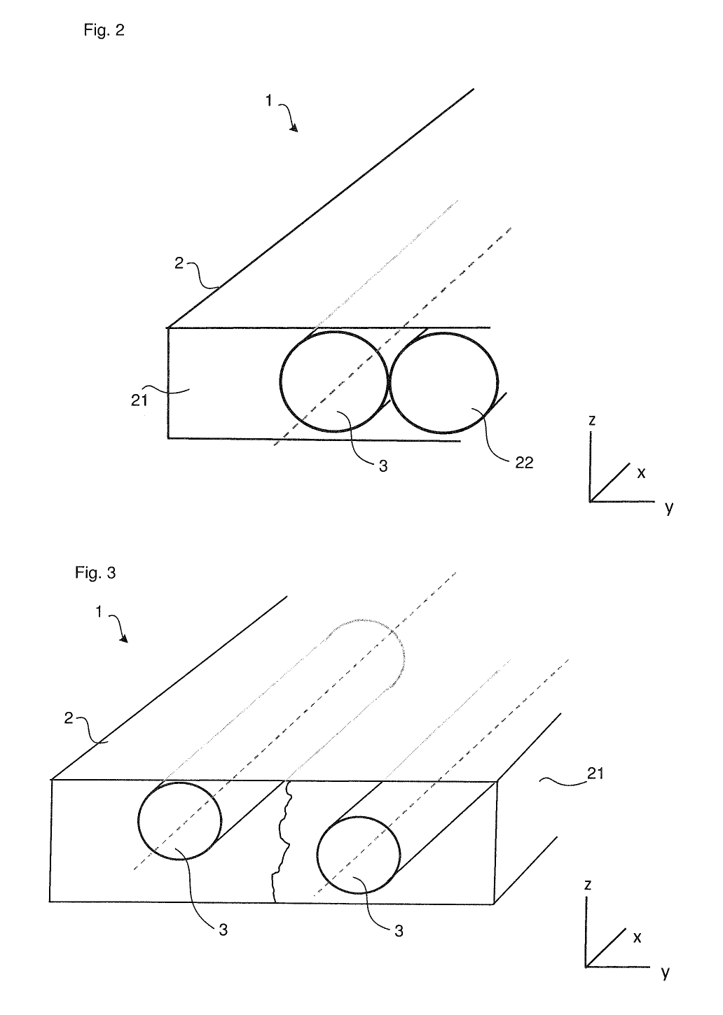

FIG. 2 shows an illumination device 1 according to a further exemplary embodiment. The fiber-composite material component 2, the plastics matrix 21, the reinforcement fibers 22, and the light-conducting body 3 can be configured as has been described in the context of FIGS. 1A and 1B, for example. By contrast to the exemplary embodiment shown in FIGS. 1A and 1B, the light-conducting body 3, at least in portions, is in physical contact with at least one of the reinforcement fibers 22. On account thereof, it can advantageously be achieved that the reinforcement fiber 22 that is in physical contact with the light-conducting body 3 can be made particularly clearly visible from the exterior. Furthermore, the light-conducting body 3, at least in portions, can be in physical contact with one further or a multiplicity of further reinforcement fibers 22. Moreover, the illumination device 1 can have further light-conducting bodies 3 which are in physical contact with one or a plurality of reinforcement fibers 22.

An illumination device 1 according to a further exemplary embodiment is illustrated in FIG. 3, wherein it is to be clarified by FIG. 3 that the light-conducting body 3 can either be disposed close to a surface in the fiber-composite material component 2, or alternatively can be embedded in the fiber-composite material component 2 so as to be farther away from the surface of the fiber-composite material component 2. Furthermore, the light-conducting body 3 can be disposed in the fiber-composite material component 2 so as to be close to the surface only in regions. It is also possible for one or a plurality of light-conducting bodies 3 to be disposed close to the surface in the fiber-composite material component 2, and at the same time for one or a plurality of light-conducting bodies 3 to be embedded in the fiber-composite material component 2 so as to be spaced farther apart from the surface of the fiber-composite material component 2. However, it is essential in terms of the arrangement of the light-conducting body 3 or bodies 3, respectively, in the fiber-composite material component 2, that the fiber-composite material component 2 is at least partially translucent to light which is de-coupled from the light exit face or faces, respectively, of the light-conducting body or bodies 3, respectively. Therefore, the light-conducting body 3 in the use of a transparent plastics matrix 21 can be spaced farther apart from the surface of the fiber-composite material component 2 than in the use of a less transparent or an opaque plastics matrix 21, respectively. For example, in the use of a transparent plastics matrix 21, none of the light-conducting bodies 3 have a spacing of more than 0.5 mm from the surface of the fiber-composite material component 21. In the use of an opaque plastics matrix 21, the light-conducting body 3 preferably has a spacing of less than 0.5 mm from the surface of the fiber-composite material component 2. The light-conducting body 3 is preferably embedded in the plastics matrix 21 in such a manner that at least 5% of the radiation energy of the light 31 that is coupled into the light-conducting body 3 exits the fiber-composite material component 2 through the plastics matrix 21.

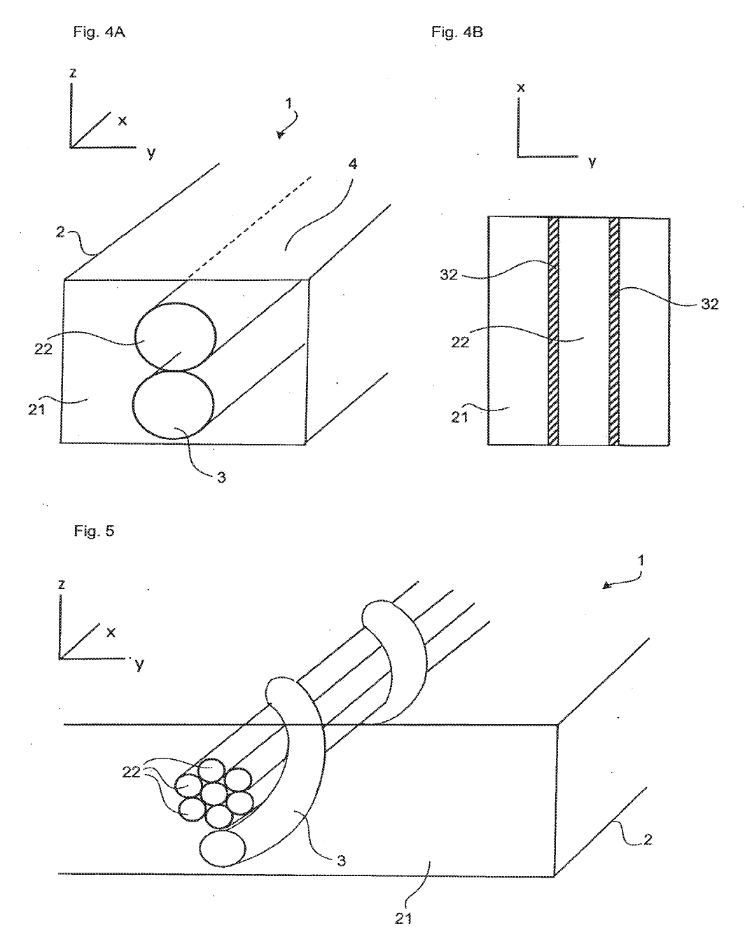

FIGS. 4A and 4B show an illumination device 1 according to a further exemplary embodiment. The light-conducting body 3 herein is embedded in the fiber-composite material component 2 in such a manner that the light-conducting body 3, when viewed from a visual surface 4 of the illumination device 1, is at least in regions covered by one of the reinforcement fibers 22. The light-conducting body 3 along the entire length thereof preferably extends along the reinforcement fiber 22 and, when viewed from the visual surface 4, is thereby largely covered by the reinforcement fiber 22. On account thereof, as can be seen in FIG. 4B which shows a plan view of the x-y plane, and thus a plan view of the visual surface 4, it can advantageously be achieved that the reinforcement fiber 22 that covers the light-conducting body 3 can be made visible to the exterior in an impressive manner, since light 32 that is de-coupled from the light-conducting body 3 highlights the external contour of the reinforcement fiber 22 in a particularly positive manner.

A further exemplary embodiment of an illumination device 1 in which the light-conducting body 3, which is configured as an optical fiber, bundles a plurality of reinforcement fibers 22 which are present in the form of a fiber bundle is shown in FIG. 5. On account thereof, the reinforcement fibers 22 can be guided or aligned, respectively, through the light-conducting body 3. The light-conducting body 3 herein is disposed in the fiber-composite material component 2 in such a manner that the former wraps the reinforcement fibers 22 multiple times. In this exemplary embodiment too, the reinforcement fibers 22 that are embedded in the fiber-composite material component 2 and wrapped by the light-conducting body 3 can be made visible to the exterior in a particularly impressive manner.

### LIST OF REFERENCE SIGNS

1 Illumination device
2 Fiber-composite material component
21 Plastics matrix
22 Reinforcement fibers
3 Light-conducting body
31 Light beam
32 De-coupled light
4 Visual surface

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An illumination device, comprising:
a fiber-composite material component which has a plastics matrix and a multiplicity of reinforcement fibers which are embedded in the plastics matrix;
at least one light source; and
at least one light-conducting body which has at least one light-introduction face for coupling in light that is emitted from the light source, and at least one light-exit face for de-coupling light, wherein
the light-conducting body is embedded in the plastics matrix of the fiber-composite material component, and
the fiber-composite material component is at least partially translucent to light which is de-coupled from the light-exit face.

2. The illumination device as claimed in claim 1, wherein the light-exit face is at least partially covered by a material of the plastics matrix.

3. The illumination device as claimed in claim 1, wherein the light-exit face extends along a main direction of extent of the light-conducting body.

4. The illumination device as claimed in claim 1, wherein a light-exit face to light-introduction face ratio is at least 10 to 1.

5. The illumination device as claimed in claim 1, wherein
at least one light-exit face of the light-conducting body is perpendicular to the light-introduction face of the light-conducting body.

6. The illumination device as claimed in claim 1, wherein
the light-conducting body is configured as an optical fiber or as an optical fiber bundle.

7. The illumination device as claimed in claim 1, wherein
the light-conducting body is composed of a plastics material, a polymethyl acrylate, or a glass.

8. The illumination device as claimed in claim 7, wherein
the plastics material is a polycarbonate, or the glass is one of more glass fibers.

9. The illumination device as claimed in claim 1, wherein the light source is embedded in the fiber-composite material component.

10. The illumination device as claimed in claim 1, wherein the light source is disposed outside the fiber-composite material component.

11. The illumination device as claimed in claim 1, wherein
the light-conducting body, at least in regions, is in physical contact with at least one of the reinforcement fibers.

12. The illumination device as claimed in claim 1, further comprising:
a multiplicity of light-conducting bodies which are embedded in the plastics matrix of the fiber-composite material component.

13. The illumination device as claimed in claim 1, wherein
the reinforcement fibers are present in the form of one fiber bundle or of a plurality of fiber bundles.

14. The illumination device as claimed in claim 1, wherein
the reinforcement fibers are embodied as a fibrous scrim, a fibrous woven fabric, a fibrous braiding and/or a fibrous embroidery.

15. The illumination device as claimed in claim 1, further comprising:
at least one sensor element that switches the light-conducting body, said sensor element being embedded in the fiber-composite material component.

16. The illumination device as claimed in claim 1, wherein
the light-conducting body bundles a plurality of reinforcement fibers, and/or is configured as an embroidery thread or a textile thread.

17. The illumination device as claimed in claim 1, wherein the reinforcement fibers are pre-impregnated fibers.
